(19) United States
(12) Patent Application Publication
(10) Pub. No.: US 2006/0034271 A1
(43) Pub. Date: Feb. 16, 2006

(54) Packet detection system and method for packet-based wireless receivers having multiple receive chains

(75) Inventors: Michael T. DiRenzo, Coppell, TX (US); David P. Magee, Plano, TX (US); Manish Goel, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/918,982

(22) Filed: Aug. 16, 2004

(51) Int. Cl. H04L 12/56

(52) U.S. Cl. 370/389

(57) ABSTRACT

A packet detection system for a packet-based wireless receiver and a method of detecting packets for use with such receiver. In one embodiment, the packet detection system includes: (1) first and second chain-level packet detection circuits and configured to produce corresponding chain-level status signals and (2) a receiver-level packet detection circuit coupled to both the first and second chain-level packet detection circuits and configured to generate receiver-level status signals from the chain-level status signals.

### TECHNICAL FIELD OF THE INVENTION

The present invention is directed, in general, to packet-based wireless communications systems and, more specifically, to a packet detection system and method for packet-based wireless receivers having multiple receive chains.

### BACKGROUND OF THE INVENTION

Wireless communication networks, which include wireless local area networks (WLANs) and cellular telephone networks, have become indispensable tools for work and leisure. The fidelity with which they communicate information from one station to another is vital to their operation and acceptance by the public.

Most modern wireless communication networks are both digital and packet-based. In such networks, data to be communicated is first converted into (if not already in) digital form and then divided into separate data packets. Each data packet is treated as a separate wireless transmission and thus includes destination address and error-checking information to ensure that it arrives at the correct station and can be detected and verified as error-free.

Wireless receivers use “receive chains” to receive and error-check the contents of data packets. A receive chain contains circuitry for demodulating (or “downconverting”) the data packet from its wireless carrier and converting it into digital form, a packet detection circuit for detecting the presence of a data packet and the boundaries between its various fields, circuitry for estimating the transmitted data in the packet, and circuitry for error-checking the data contained in the packet. The output of the packet detection circuit provides various status and control signals to the remainder of the receive chain circuitry so that error-free reception of the data packet can be accomplished. Many conventional, proven, industry-accepted designs for receive chains exist today.

Some wireless receiver architectures use multiple receive chains concurrently in the receipt of data packets. One such architecture is Multiple-Input, Multiple-Output (MIMO), which transmits data packets by distributing them over both space and time using Orthogonal Frequency-Division Multiplexing (OFDM).

Determining whether or not received data packets should be processed or discarded as invalid is a relatively straightforward process in wireless receivers having single receive chains; the status and control signals emanating from the packet detection circuit of a single receive chain provide an objective basis for activating the data estimation and error-checking circuitry in the receive chain. However, wireless receivers having multiple receive chains are more complex; not all receive chains may agree with one another as to the existence of a particular data packet. Resolving differences between status signals emanating from the packet detection circuit of the multiple receive chains therefore becomes a matter of judgment.

Typically, one of the receive chains will receive the wireless transmission with a higher signal strength than the others and will be more likely to make a correct decision on the presence of a data packet. Thus, treating each receive chain's status signals independently will not always lead to suitable judgment. On the other hand, modifying the packet detection circuit of existing receive chain designs so they can be used in multiple receive chain receivers is expensive and time-consuming.

What is needed in the art is a better way to detect packets in a wireless receiver having multiple receive chains. A particularly advantageous contribution to the art is a way to use proven single receive chain designs in multiple receive chain wireless receivers without requiring significant modification to their packet detection circuit.

### SUMMARY OF THE INVENTION

To address the above-discussed deficiencies of the prior art, one aspect of the present invention provides a packet detection system for a packet-based wireless receiver. In one embodiment, the packet detection system includes: (1) first and second chain-level packet detection circuits configured to produce corresponding chain-level status signals and (2) a receiver-level packet detection circuit coupled to both the first and second chain-level packet detection circuits and configured to generate receiver-level status signals from the chain-level status signals.

In another aspect, the present invention provides a packet detection method for a packet-based wireless receiver. In one embodiment, the packet detection method includes: (1) producing chain-level status signals with corresponding first and second chain-level packet detection circuits and (2) generating receiver-level status signals from the chain-level status signals.

In yet another aspect, the present invention provides a packet-based wireless receiver. In one embodiment, the receiver includes: (1) a plurality of receive chains having a corresponding plurality of chain-level packet detection circuits configured to produce chain-level status signals for each of the plurality of receive chains and (2) a receiver-level packet detection circuit coupled to at least some of the plurality of chain-level packet detection circuits and configured to generate receiver-level status signals from at least some of the chain-level status signals.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of one embodiment of the portion of a single receive chain relevant to packet detection, suitable for use in a packet-based wireless receiver having multiple receive chains and constructed according to the principles of the present invention;

FIG. 2 illustrates a block diagram of one embodiment of the portion of a packet-based wireless receiver relevant to packet detection, having multiple receive-chains and containing a packet detection system for a packet-based wireless receiver constructed according to the principles of the present invention;

FIG. 3 illustrates a schematic diagram of one embodiment of a logic module of a first type employable within the packet detection system of FIG. 2;

FIG. 4 illustrates a schematic diagram of one embodiment of a logic module of a second type employable within the packet detection system of FIG. 2; and

FIG. 5 illustrates a flow diagram of one embodiment of a packet detection method for a packet-based wireless receiver carried out according to the principles of the present invention.

### DETAILED DESCRIPTION

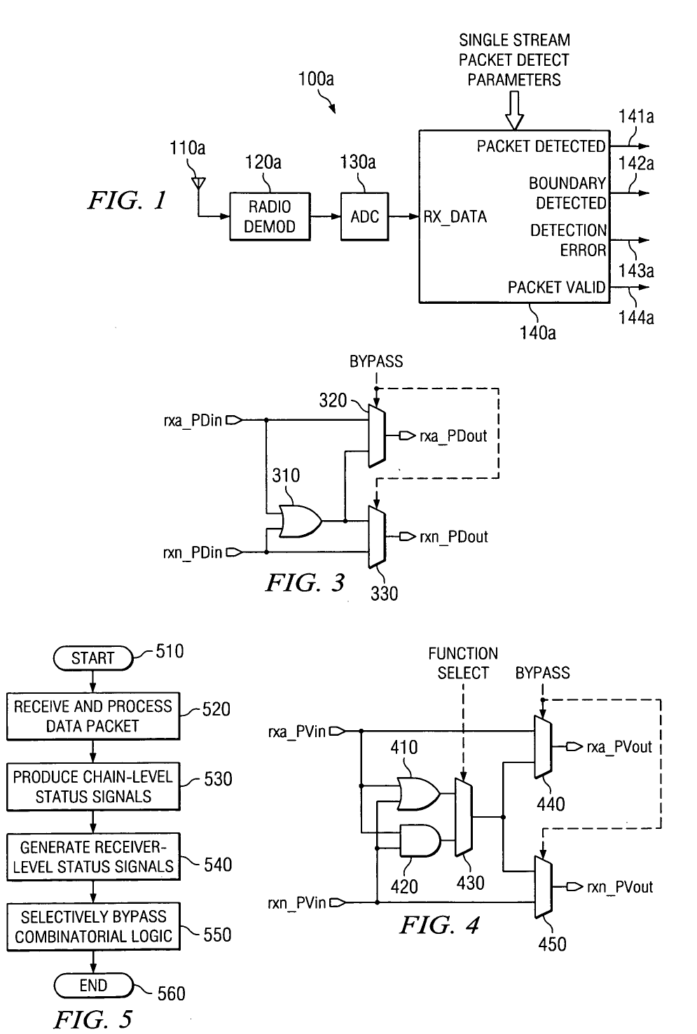

Referring initially to FIG. 1, illustrated is a block diagram of one embodiment of a single receive chain 100a suitable for use in a packet-based wireless receiver having multiple receive chains and constructed according to the principles of the present invention.

The receive chain 100a is used to receive a data packet conventionally used in wireless communication networks. The general structure of such a data packet will now be described.

The data packet has three fields: an acquisition field, a training field and a data field. The acquisition field is used for detection of a valid packet and for setting the level on an automatic gain control (AGC) within the receive chain 100a. The training field is used for estimation or equalization of the wireless channel characteristics needed for successful decoding of the data field. A first boundary separates the acquisition field from the training field. A second boundary separates the training field from the data field. The wireless receiver knows the content of the acquisition and training fields beforehand and therefore can ascertain where the boundaries are located in a valid data packet.

Conceptually, all packet detection algorithms operating on a single receive stream will provide: (1) a signal indicating that a packet has been found, (2) a signal indicating the boundary between the acquisition field and the training field has been found and (3) a signal indicating the boundary between the training field and the data field has been found (because the training field is known, this signal is redundant to the boundary between the acquisition field and the training field).

In the context of a wireless receiver having only a single receive chain 100a, these signals allow the receiver to enable or disable the appropriate signal processing algorithms pertaining to the part of the packet currently being received. Additionally, robustness can be added to a packet detection algorithm when it provides: (4) a signal indicating that a packet was detected in error and (5) a signal indicating that a packet was correctly detected with high probability.

The receive chain 100a illustrated in FIG. 1 by itself is entirely conventional when used in the context of a wireless receiver having only a single receive chain 100a. However, the present invention is advantageously employable to allow the conventional receive chains 100a to be used as one of the receive chain 100as in a wireless receiver having multiple such chains. Thus, the general architecture of an exemplary receive chain 100a will now be described.

The exemplary receive chain 100a includes an antenna 110a that receives a data packet in the form of symbols modulated onto a carrier wave. A radio demodulator 120a demodulates (downconverts) by stripping away the carrier wave thereby to extract analog symbols representing the data packet. An analog-to-digital converter (ADC) 130a converts the analog symbols into a stream of bits representing the acquisition field, training field and data field of the data packet. The stream of bits then progresses into a chain-level packet detection circuit 140a that uses single stream packet detect parameters, such as threshold and counter duration, to examine the acquisition, training and data fields and the boundaries between those fields and thereby to determine the validity of the data packet. In the process, the chain-level packet detection circuit 140a produces chain-level status signals. In the illustrated embodiment, those chain-level status signals are: a chain-level packet detected signal 141a, a chain-level boundary detected signal 142a, a chain-level detection error signal 143a and a chain-level packet valid signal 144a. Those skilled in the art are familiar with the manner in which the receive chain 100a of FIG. 1 receives, downconverts, converts to digital form and produces the various chain-level status signals 141a, 142a, 143a, 144a. Therefore, such will not be described further.

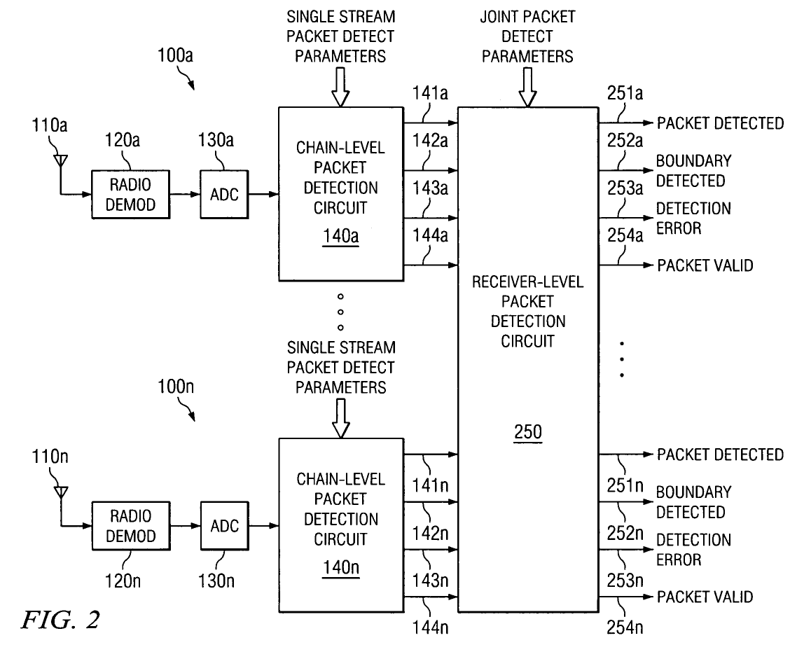

Having described a single receive chain 100a, a packet detection system suitable for multiple receive chains can now be described. Accordingly, turning now to FIG. 2, illustrated is a block diagram of one embodiment of a packet-based wireless receiver having multiple receive-chains 100a, 100n and containing a packet detection system for a packet-based wireless receiver constructed according to the principles of the present invention.

Shown is the receive chain 100a of FIG. 1, including the antenna 110a, radio demodulator 120a, ADC 130a, chain-level packet detection circuit 140a and chain-level status signals 141a, 142a, 143a, 144a. FIG. 2 shows a further receive chain 100n including a corresponding antenna 110n, radio demodulator 120n, ADC 130n, chain-level packet detection circuit 140n and chain-level status signals 141n, 142n, 143n, 144n. It is presumed for purposes of describing FIG. 2 that the receive chain 100n is identical in structure and operation to the receive chain 100a, but such need not be the case according to the broad principles of the present invention. Further, although only two receive chains 100a, 100n are shown (which would be appropriate for, e.g., a 2×2 MIMO receiver), additional receive chains may be included in the wireless receiver. In fact, the ellipsis illustrated between the receive chains 100a, 100n and the notation “n” with respect to the receive chain 100n is intended to indicate that additional chains may be included.

A receiver-level packet detection circuit 250 is illustrated as being coupled to the chain-level packet detection circuits 100a, 100n. The receiver-level packet detection circuit 250 contains combinatorial logic that generates receiver-level status signals from the chain-level status signals. More specifically, the receiver-level packet detection circuit 250 generates a receiver-level packet detected signal 251a, a receiver-level boundary detected signal 252a, a receiver-level detection error signal 253a, a receiver-level packet valid signal 254a, a receiver-level packet detected signal 251n, a receiver-level boundary detected signal 252n, a receiver-level detection error signal 253n and a receiver-level packet valid signal 254n.

As will be described more particularly with respect to FIG. 3, the receiver-level packet detection circuit 250 operates in a normal mode in which the receiver-level packet detected signal 251a and the receiver-level packet detected signal 251n are identical, the receiver-level boundary detected signal 252a and the receiver-level boundary detected signal 252n are identical, the receiver-level detection error signal 253a and the receiver-level detection error signal 253n are identical and the receiver-level packet valid signal 254a and receiver-level packet valid signal 254n are identical. In an alternative complete bypass mode, the receiver-level packet detected signal 251a is identical to the chain-level packet detected signal 141a, the receiver-level boundary detected signal 252a is identical to the chain-level boundary detected signal 142a, the receiver-level detection error signal 253a is identical to the chain-level detection error signal 143a, the receiver-level packet valid signal 254a is identical to the chain-level packet valid signal 144a, the receiver-level packet detected signal 251n is identical to the chain-level packet detected signal 141n, the receiver-level boundary detected signal 252n is identical to the chain-level boundary detected signal 142n, the receiver-level detection error signal 253n is identical to the chain-level detection error signal 143n and the receiver-level packet valid signal 254n is identical to the chain-level packet valid signal 144n. In alternative partial bypass modes, only some of the signals 141a, 142a, 143a, 144a, 141n, 142n, 143n, 144n may bypass the receiver-level packet detection circuit 250.

Joint packet detect parameters are employed to determine whether the receiver-level packet detection circuit 250 operates in its normal mode, alternative complete bypass mode or partial bypass modes. The joint packet detect parameters may also be employed to determine how the combinatorial circuitry within the receiver-level packet detection circuit 250 processes the signals 141a, 142a, 143a, 144a, 141n, 142n, 143n, 144n to generate the signals 251a, 252a, 253a, 254a, 251n, 252n, 253n, 254n.

Having described a packet-based wireless receiver having multiple receive-chains and a suitable packet detection system, exemplary types of logic modules of combinatorial circuitry that may be contained within the receiver-level packet detection circuit 250 may now be described. Accordingly, turning now to FIG. 3, illustrated is a schematic diagram of one embodiment of a logic module of a first type employable within the packet detection system of FIG. 2. The logic module of FIG. 3 may be used, for example, to generate the receiver-level packet detected signals 251a, 251n from the chain-level packet detected signals 141a, 141n or to generate the receiver-level boundary detected signals 252a, 252n from the chain-level boundary detected signals 142a, 142n. The illustrated embodiment of the logic module of FIG. 3 performs the former task.

The logic module has two inputs rxa_PDin, rxn_PDin, which receive the chain-level packet detected signals 141a, 141n. rxa_PDin, rxn_PDin are coupled to an OR gate 310 and first and second multiplexers 320, 330, which constitute bypass logic in the logic module of FIG. 3. The output of the OR gate 310 is also coupled to the first and second multiplexers 320, 330. The outputs of the first and second multiplexers 320, 330 are provided to outputs rxa_PDout, rxn_PDout, which provide the receiver-level packet detected signals 251a, 251n.

In a normal mode of operation, the chain-level packet detected signals 141a, 141n are OR'd and pass through the bypass logic (the first and second multiplexers 320, 330) to produce both of the receiver-level packet detected signals 251a, 251n. If, however, a BYPASS signal (one of the joint packet detect parameters) is provided to the bypass logic, the output of the OR gate 310 is ignored, and the chain-level packet detected signals 141a, 141n directly provide the receiver-level packet detected signals 251a, 251n. Of course, any logic module containing any combinatorial logic may be substituted for the logic module of FIG. 3.

Turning now to FIG. 4, illustrated is a schematic diagram of one embodiment of a logic module of a second type employable within the packet detection system of FIG. 2. The logic module of FIG. 4 may be used, for example, to generate the receiver-level detection error signals 253a, 253n from the chain-level detection error signals 143a, 143n or to generate the receiver-level packet valid signals 254a, 254n from the chain-level packet valid signals 144a, 144n. The illustrated embodiment of the logic module of FIG. 4 performs the latter task.

The logic module has two inputs rxa_PVin, rxn_PVin, which receive the chain-level packet valid signals 144a, 144n. rxa_PVin, rxn_PVin are coupled to parallel-coupled OR and AND gates 410, 420 and to first and second multiplexers 440, 450, which constitute bypass logic in the logic module of FIG. 4. The outputs of the OR and AND gates 410, 420 are provided to a function select multiplexer 430. The output of the function select multiplexer 430 is coupled to the first and second multiplexers 440, 450. The outputs of the first and second multiplexers 440, 450 are provided to outputs rxa_PVout, rxn_PVout, which provide the receiver-level packet valid signals 254a, 254n.

In a normal mode of operation, a FUNCTION SELECT signal (one of the joint packet detect parameters) causes the function select multiplexer 430 to select either the OR gate 410 or the AND gate 420 as the appropriate combinatorial gate to use to compare the chain-level packet valid signals 144a, 144n. The output of the function select multiplexer 430 passes through the bypass logic (the first and second multiplexers 440, 450) to produce both of the receiver-level packet valid signals 254a, 254n. If, however, a BYPASS signal (one of the joint packet detect parameters) is provided to the bypass logic, the output of the function select multiplexer 430 is ignored, and the chain-level packet valid signals 144a, 144n directly provide the receiver-level packet valid signals 254a, 254n. Of course, any logic module containing any combinatorial logic may be substituted for the logic module of FIG. 4.

Turning now to FIG. 5, illustrated is a flow diagram of one embodiment of a packet detection method for a packet-based wireless receiver carried out according to the principles of the present invention.

The method begins in a start step 510 wherein it is desired to detect data packets. The incoming wireless signal is received and processed (e.g., demodulated and converted to digital form) in a step 520. Thereafter, chain-level status signals are produced from corresponding first and second chain-level packet detection circuits in a step 530.

Next, in a step 540, receiver-level status signals are generated from the chain-level status signals. This step may be performed as outlined above or by any other appropriate method.

In a step 550, some or all of the combinatorial logic involved in generating the receiver-level status signals may be bypassed. Of course, this need not be the case. The steps 520 through 550 are repeated until, in a step 553, a valid data packet is recognized. In that case, a step 557 is performed, wherein the transmitted data is estimated and checked for errors in the receive process. The method ends in an end step 560.

While the methods disclosed herein has been described and shown with reference to particular steps performed in a particular order, those skilled in the pertinent art will understand that these steps may be combined, subdivided, or reordered to form an equivalent method without departing from the teachings of the present invention. Accordingly, unless specifically indicated herein, the order and/or the grouping of the steps are not limitations of the present invention.

Although the present invention has been described in detail, those skilled in the art should understand that they can make various changes, substitutions and alterations herein without departing from the spirit and scope of the invention in its broadest form.

What is claimed is:

1. A packet detection system for a packet-based wireless receiver, comprising:
first and second chain-level packet detection circuits and configured to produce corresponding chain-level status signals; and
a receiver-level packet detection circuit coupled to both said first and second chain-level packet detection circuits and configured to generate receiver-level status signals from said chain-level status signals.

2. The system as recited in claim 1 wherein said chain-level status signals are selected from the group consisting of:
a chain-level packet detected signal,
a chain-level boundary detected signal,
a chain-level detection error signal, and
a chain-level packet valid signal.

3. The system as recited in claim 1 wherein said receiver-level status signals are selected from the group consisting of:
a receiver-level packet detected signal,
a receiver-level boundary detected signal,
a receiver-level detection error signal, and
a receiver-level packet valid signal.

4. The system as recited in claim 1 wherein said combinatorial circuit comprises a logic module of a first type having an OR gate configured to combine one of said chain-level status signals from each of said first and second chain-level packet detection circuits to generate one of said receiver-level status signals.

5. The system as recited in claim 4 wherein said module of said first type comprises bypass logic configured to allow said one of said chain-level status signals from said each to bypass said OR gate.

6. The system as recited in claim 1 wherein said combinatorial circuit comprises a logic module of a second type having parallel-coupled AND and OR gates configured to combine one of said chain-level status signals from each of said first and second chain-level packet detection circuits to generate intermediate signals and selection logic coupled to said AND and OR gates and configured to select one of said intermediate signals to provide one of said receiver-level status signals.

7. The system as recited in claim 6 wherein said module of said second type comprises bypass logic configured to allow said one of said chain-level status signals from said each to bypass said AND and OR gate and said selection logic.

8. A packet detection method for a packet-based wireless receiver, comprising:
producing chain-level status signals with corresponding first and second chain-level packet detection circuits; and
generating receiver-level status signals from said chain-level status signals.

9. The method as recited in claim 8 wherein said chain-level status signals are selected from the group consisting of:
a chain-level packet detected signal,
a chain-level boundary detected signal,
a chain-level detection error signal, and
a chain-level packet valid signal.

10. The method as recited in claim 8 wherein said receiver-level status signals are selected from the group consisting of:
a receiver-level packet detected signal,
a receiver-level boundary detected signal,
a receiver-level detection error signal, and
a receiver-level packet valid signal.

11. The method as recited in claim 8 wherein said generating comprises employing a logic module of a first type having an OR gate to combine one of said chain-level status signals from each of said first and second chain-level packet detection circuits to generate one of said receiver-level status signals.

12. The method as recited in claim 11 wherein said employing comprises allowing said one of said chain-level status signals from said each to bypass said OR gate.

13. The method as recited in claim 8 wherein said generating comprises employing a logic module of a second type having parallel-coupled AND and OR gates configured to combine one of said chain-level status signals from each of said first and second chain-level packet detection circuits to generate intermediate signals and selection logic coupled to said AND and OR gates and configured to select one of said intermediate signals to provide one of said receiver-level status signals.

14. The method as recited in claim 13 wherein said employing comprises allowing said one of said chain-level status signals from said each to bypass said AND and OR gate and said selection logic.

15. A packet-based wireless receiver, comprising:
a plurality of receive chains having a corresponding plurality of chain-level packet detection circuits configured to produce chain-level status signals for each of said plurality of receive chains; and
a receiver-level packet detection circuit coupled to at least some of said plurality of chain-level packet detection circuits and configured to generate receiver-level status signals from at least some of said chain-level status signals.

16. The system as recited in claim 15 wherein said chain-level status signals are selected from the group consisting of:
a chain-level packet detected signal,
a chain-level boundary detected signal,
a chain-level detection error signal, and
a chain-level packet valid signal.

17. The system as recited in claim 15 wherein said receiver-level status signals are selected from the group consisting of:
a receiver-level packet detected signal,
a receiver-level boundary detected signal,
a receiver-level detection error signal, and
a receiver-level packet valid signal.

18. The system as recited in claim 15 wherein said combinatorial circuit comprises a logic module of a first type having an OR gate configured to combine one of said chain-level status signals from each of said first and second chain-level packet detection circuits to generate one of said receiver-level status signals.

19. The system as recited in claim 18 wherein said module of said first type comprises bypass logic configured to allow said one of said chain-level status signals from said each to bypass said OR gate.

20. The system as recited in claim 15 wherein said combinatorial circuit comprises a logic module of a second type having parallel-coupled AND and OR gates configured to combine one of said chain-level status signals from each of said first and second chain-level packet detection circuits to generate intermediate signals and selection logic coupled to said AND and OR gates and configured to select one of said intermediate signals to provide one of said receiver-level status signals.

21. The system as recited in claim 20 wherein said module of said second type comprises bypass logic configured to allow said one of said chain-level status signals from said each to bypass said AND and OR gate and said selection logic.
